(19) United States
(12) Patent Application Publication
(10) Pub. No.: US 2023/0315130 A1
(43) Pub. Date: Oct. 5, 2023

(54) MOBILE BODY CONTROL DEVICE, MOBILE BODY CONTROL METHOD, AND NON-TRANSITORY COMPUTER-READABLE STORAGE MEDIUM

(71) Applicant: HONDA MOTOR CO., LTD., Tokyo (JP)

(72) Inventors: Misa KOMURO, Wako-shi (JP); Yutaka NISHIZAKI, Tokyo (JP)

(21) Appl. No.: 18/118,932

(22) Filed: Mar. 8, 2023

(30) Foreign Application Priority Data
Mar. 31, 2022 (JP) 2022-060619

(51) Int. Cl. G05D 1/12; G06F 21/31

(52) U.S. Cl. CPC G05D 1/12; G06F 21/31; G10L 15/22

(57) ABSTRACT

A mobile body control device acquires captured image for recognizing an object around a mobile body, sets one of a plurality of traveling modes, and controls traveling of the mobile body based on the set traveling mode and a result of detection of a specific person based on the captured image. The plurality of traveling modes includes a standby mode of standing by at a specific point until any one of the traveling modes is started or resumed. In a case where movement of the specific person or movement of the mobile body satisfies a predetermined criterion to wait while being away from the specific person, the device shifts from one of the traveling modes to the standby mode.

### CROSS-REFERENCE TO RELATED APPLICATION(S)

This application claims priority to and the benefit of Japanese Patent Application No. 2022-060619 filed on Mar. 31, 2022, the entire disclosure of which is incorporated herein by reference.

### BACKGROUND OF THE INVENTION

### Field of the Invention

The present invention relates to a mobile body control device, a mobile body control method, and a non-transitory computer-readable storage medium.

### Description of the Related Art

In recent years, robots that carry a load of a user and self-propelled vehicles that lead a user in an airport have been known (Japanese Patent Laid-Open No. 2021-64214 and Japanese Patent Laid-Open No. 2021-22108). Japanese Patent Laid-Open No. 2021-64214 proposes a technology in which a transport robot holding a load of a user keeps an appropriate distance from the user and follows the user. In addition, Japanese Patent Laid-Open No. 2021-22108 proposes a technology in which a self-propelled vehicle derives a traveling route to a boarding place where a user boards an aircraft, and leads the user to the boarding place according to the traveling route while preventing a distance from the user from becoming a predetermined distance or more. Furthermore, International Publication No. WO2017/115548 discloses a technology in which a mobile body moves to an appropriate position in front of a user, such as a position obliquely in front of the user, and follows the user.

Meanwhile, in an amusement facility, a large commercial facility, an airport, a park, a parking lot, and the like, various people move in a wide site. Among these people, there are some people who want to move with a less burden of carrying a load, some people who wants a guide to a desired place, and some people who want to ease movement in a crowd moving in front of the people.

For a mobile body such as a mobile robot that assists movement of a person, assistance in various moving modes as described above, and movement assistance with further improved usability, safety, and the like have been requested.

### SUMMARY OF THE INVENTION

The present invention has been made in view of the above problems, and an object of the present invention is to implement a technology capable of more appropriately assisting movement of a person in a site.

In order to solve the aforementioned issues, one aspect of the present disclosure provides a mobile body control device comprising: one or more processors; and a memory storing instructions which, when the instructions are executed by the one or more processors, cause the mobile body control device to function as: an acquisition unit configured to acquire sensor information for recognizing an object around a mobile body, the sensor information including a captured image obtained by capturing a periphery of the mobile body; a setting unit configured to set one of a plurality of control modes; and a control unit configured to control traveling of the mobile body based on the set control mode and a result of detection of a specific person based on the sensor information, wherein the plurality of control modes include a plurality of traveling modes of traveling together with the specific person when the person is walking, and a standby mode of standing by at a specific point until any one of the traveling modes is started or resumed, the control unit controls the traveling of the mobile body in such a way that the mobile body travels together with the specific person when the person is walking in the plurality of traveling modes, and in a case where it is determined that movement of the specific person or movement of the mobile body satisfies a predetermined criterion for the mobile body to wait while being away from the specific person, the control unit shifts from one of the traveling modes to the standby mode.

Another aspect of the present disclosure provides a mobile body control method comprising: acquiring sensor information for recognizing an object around a mobile body, the sensor information including a captured image obtained by capturing a periphery of the mobile body; setting one of a plurality of control modes; and controlling traveling of the mobile body based on the set control mode and a result of detection of a specific person based on the sensor information, wherein the plurality of control modes include a plurality of traveling modes of traveling together with the specific person when the person is walking, and a standby mode of standing by at a specific point until any one of the traveling modes is started or resumed, in the controlling, the traveling of the mobile body is controlled in such a way that the mobile body travels together with the specific person when the person is walking in the plurality of traveling modes, and in the controlling, in a case where it is determined that movement of the specific person or movement of the mobile body satisfies a predetermined criterion for the mobile body to wait while being away from the specific person, shifting from one of the traveling modes to the standby mode is made.

Still another aspect of the present disclosure provides a non-transitory computer-readable storage medium storing a program for causing a computer to function as each unit of a mobile body control device, the mobile body control device including: an acquisition unit that acquire sensor information for recognizing an object around a mobile body, the sensor information including a captured image obtained by capturing a periphery of the mobile body; a setting unit that sets one of a plurality of control modes; and a control unit that controls traveling of the mobile body based on the set control mode and a result of detection of a specific person based on the sensor information, wherein the plurality of control modes include a plurality of traveling modes of traveling together with the specific person when the person is walking, and a standby mode of standing by at a specific point until any one of the traveling modes is started or resumed, the control unit controls the traveling of the mobile body in such a way that the mobile body travels together with the specific person when the person is walking in the plurality of traveling modes, and in a case where it is determined that movement of the specific person or movement of the mobile body satisfies a predetermined criterion for the mobile body to wait while being away from the specific person, the control unit shifts from one of the traveling modes to the standby mode.

Further features of the present invention will become apparent from the following description of exemplary embodiments (with reference to the attached drawings).

### BRIEF DESCRIPTION OF THE DRAWINGS

FIG. 1 is a diagram illustrating an example of a movement assistance system according to an embodiment of the present invention;

FIG. 2 is a diagram illustrating an external configuration example of a robot as an example of a mobile body according to the embodiment;

FIG. 3A is a block diagram illustrating a functional configuration example of the mobile body according to the embodiment;

FIG. 3B is a block diagram illustrating a functional configuration example of a server as an example of an information processing device according to the embodiment;

FIG. 4A is a diagram illustrating an example of transition of a control mode of the mobile body according to the embodiment;

FIG. 4B is a diagram illustrating an example when the mobile body is used in a large commercial facility according to the embodiment;

FIG. 4C is a diagram for explaining some control modes of the mobile body according to the embodiment;

FIG. 5A is Table (1) for explaining characteristics of each control mode of the mobile body according to the embodiment;

FIG. 5B is Table (2) for explaining characteristics of each control mode of the mobile body according to the embodiment;

FIG. 6A is a flowchart illustrating an example of processing related to state control of the mobile body according to the embodiment;

FIG. 6B is a flowchart illustrating an example of processing related to a leading mode of the mobile body according to the embodiment;

FIG. 6C is a flowchart illustrating an example of processing related to a follow mode of the mobile body according to the embodiment;

FIG. 6D is a flowchart illustrating an example of processing related to a guide mode of the mobile body according to the embodiment; and

FIG. 6E is a flowchart illustrating an example of processing related to a delivery mode of the mobile body according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Configuration of Movement Assistance System>

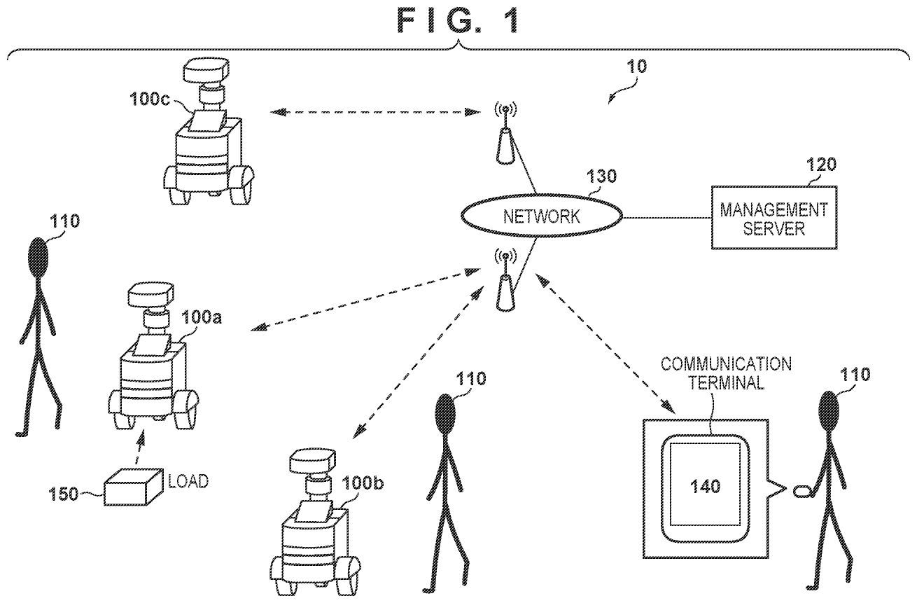

A configuration of a movement assistance system 10 according to the present embodiment will be described with reference to FIG. 1. A mobile body 100 is, for example, a robot capable of autonomous traveling. For example, the mobile body 100 is equipped with a battery and moves mainly by power of a motor. The mobile body 100 travels in a site such as an amusement facility, a large commercial facility, an airport, a park, a sidewalk, or a parking lot.

The mobile body 100 can guide a specific person (also referred to as a user) to a specific location in a space, can store a load of the user in a housing and follow the user, or can deliver a load from a specific location in a space to a location of a user (or from the location of the user to the specific location). In the space, each of a plurality of mobile bodies 100 autonomously operates. In a case where the respective mobile bodies are distinguished in the description, the mobile bodies are denoted by different reference signs such as 100a, 100b, and the like, but in a case where the individual mobile bodies are not distinguished, the mobile bodies are simply described as the mobile bodies 100.

In the present embodiment, a configuration in which a person does not get on the mobile body 100 will be described as an example. However, when the mobile body travels side by side with a walking user, another person may get on the mobile body. Furthermore, in the present embodiment, a case where the mobile body moves by driving wheels will be described as an example, but another autonomously movable mobile body (for example, a walking robot) that can walk with two or more legs may be included.

The mobile body 100 can be connected to a network 130 via wireless communication such as 5th generation mobile communication, wireless local area network (LAN), or communication between mobile bodies. The mobile body 100 autonomously moves between stations to be described later or moves to a point designated by a user 110 according to an instruction from a management server 120. The mobile body 100 can measure internal and external states of the mobile body (a position of the mobile body, a traveling state, a target of a surrounding object, and the like) by various sensors to be described later and accumulate measured data. The mobile body 100 may transmit at least a part of the accumulated data to the management server 120. In a case where information regarding the mobile body 100 is transmitted to the management server 120, the information regarding the mobile body 100 is transmitted at regular intervals or in response to an occurrence of a specific event.

A communication terminal 140 is, for example, a smartphone, but is not limited thereto, and may be an earphone type communication terminal, a personal computer, a tablet terminal, a game machine, smart glasses, a smart watch, or the like. The communication terminal 140 is connected to the network 130 via wireless communication such as 5th generation mobile communication or wireless LAN.

The network 130 includes, for example, a communication network such as the Internet or a mobile phone network, and transmits information between the mobile body 100, the management server 120, the communication terminal 140, and the like.

<External Configuration of Mobile Body>

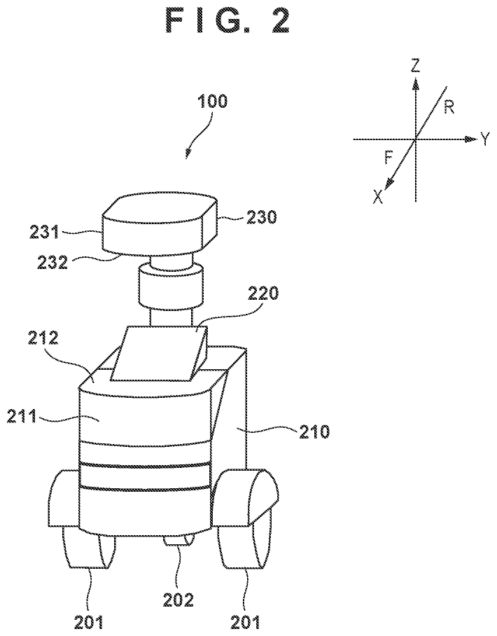

Next, an external configuration example of the mobile body 100 according to the present embodiment will be described with reference to FIG. 2. In FIG. 2, an arrow X indicates a front-and-rear direction of the mobile body 100, F indicates the front, and R indicates the rear. Arrows Y and Z indicate a width direction (a left-and-right direction) and a vertical direction of the mobile body 100, respectively.

The mobile body 100 includes, for example, a pair of left and right front wheels 201 and a rear wheel 202 included in a traveling unit 304 to be described later. The traveling unit 304 may be in another form such as a four-wheeled vehicle or a two-wheeled vehicle.

The mobile body 100 includes a housing 210 capable of storing a load. A lid that is openable and closable to store a load is provided on a front surface 211 of the housing, and the lid includes a lock mechanism. The lock mechanism is controlled by the mobile body 100. For example, the mobile body 100 unlocks the lid in a case where authentication of the user is successful. A monitor 220 including a touch panel is arranged on an upper surface 212 of the housing, and the user can select a control mode of the mobile body 100, designate a desired destination, and confirm information regarding a facility, for example.

A sensor box 230 includes a detection unit 306 that is provided in the sensor box 230 and generates data for recognizing an object or the user existing around the mobile body 100 through a front surface 231, a side surface, or the like of the sensor box 230. Furthermore, a vein sensor for authenticating the user (specific person) who uses the mobile body 100 is arranged on a bottom surface portion 232 of the sensor box 230. In the present embodiment, the user is identified by detecting and recognizing a feature amount of the vein of the palm of the user with the vein sensor.

<Functional Configuration Example of Mobile Body>

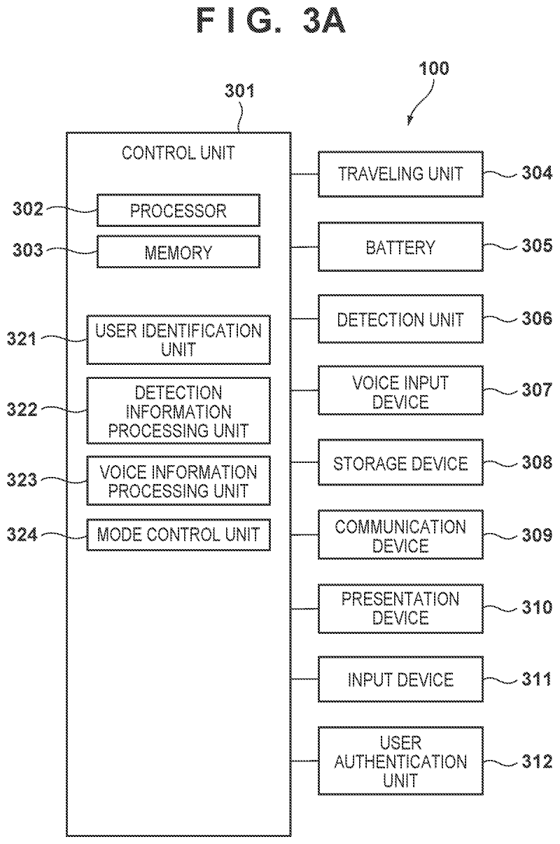

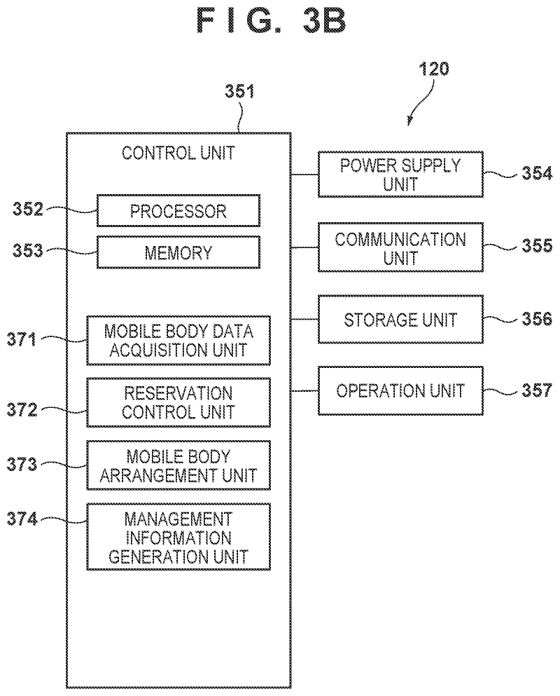

Next, a functional configuration example of the mobile body 100 according to the present embodiment will be described with reference to FIG. 3A.

The mobile body 100 is an electric autonomous mobile body including the traveling unit 304 and using a battery 305 as a main power supply. The battery 305 is, for example, a secondary battery such as a lithium ion battery, and the mobile body 100 autonomously travels by the traveling unit 304 using power supplied from the battery 305.

The traveling unit 304 includes a steering mechanism. The steering mechanism changes a steering angle of the pair of front wheels 201 by using a first motor as a drive source. A traveling direction of the mobile body 100 can be changed by changing the steering angle of the pair of front wheels 201. The traveling unit 304 further includes a drive mechanism. The drive mechanism rotates the rear wheel 202 by using a second motor as a drive source. The mobile body 100 can be moved forward or backward by rotating the rear wheel 202. The traveling unit 304 can detect and output physical quantities representing motions of the mobile body 100, such as a traveling speed, acceleration, and steering angle of the mobile body 100, and a rotational acceleration of a body of the mobile body 100.

The mobile body 100 includes the detection unit 306. The detection unit 306 generates data for recognizing an object (including an object and a person existing around the mobile body) existing around the mobile body 100. The detection unit 306 includes sensors such as an imaging device, a radar device, a light detection and ranging (LiDAR), and an ultrasonic sensor whose detection range is the periphery of the mobile body 100, and outputs sensor information. The imaging device may have a configuration using a fisheye lens, or a set of a plurality of imaging devices capable of stereo imaging may be arranged in a plurality of directions. The detection unit 306 further includes a global navigation satellite system (GNSS) sensor to receive a GNSS signal and detect a current position of the mobile body 100. The detection unit 306 may detect the current position by using a signal of a wireless LAN or Bluetooth (registered trademark).

The mobile body 100 includes a control unit (ECU) 301. The control unit 301 functions as a mobile body control device. The control unit 301 includes one or more processors 302 represented by a central processing unit (CPU), and a memory 303 which is a storage device such as a semiconductor memory. The memory 303 stores a program to be executed by the processor 302, data used for processing in the processor 302, and the like. A plurality of sets of the processor 302 and the memory 303 may be provided for each function of the mobile body 100 in such a way as to be able to communicate with each other.

The control unit 301 acquires the physical quantity representing the motion, output from the traveling unit 304, a detection result of the detection unit 306, input information of an operation panel 31, voice information input from a voice input device 307, and the like, and executes corresponding processing. For example, the control unit 301 performs control of the motor of the traveling unit (traveling control of the traveling unit 304), display control of the operation panel 31, broadcasting to surrounding persons by voice, transmission of information to the management server 120, and the like. In addition to the CPU, the control unit 301 may further include, as a processor, a graphical processing unit (GPU) or dedicated hardware suitable for executing processing of a machine learning model such as a neural network. In addition, the control unit 301 executes processing and the like related to state control according to the present embodiment to be described later.

The voice input device 307 collects a voice around the mobile body 100. The control unit 301 can recognize the input voice and execute processing corresponding to the recognized input voice. A storage device 308 is a nonvolatile mass storage device that stores map information and the like including information of a traveling road on which the mobile body 100 can travel, a region where entry is limited, a landmark, a store, and the like. In the storage device 308, programs executed by the processor 302, data used for processing by the processor 302, and the like may be stored. The storage device 308 may store various parameters (for example, learned parameters of a deep neural network, hyperparameters, and the like) of a machine learning model for voice recognition or image recognition executed by the control unit 301.

A communication device 309 is, for example, a communication device that can be connected to the network 130 via wireless communication such as 5th generation mobile communication or wireless LAN.

A presentation device 310 displays (presents) a user interface screen for the user on the monitor 220, and outputs (presents) a speech to the periphery of the mobile body 100 via a microphone. In a case where there is information to be presented to the user, the mobile body 100 may transmit the information to be presented to the communication terminal 140 possessed by the user (specific person) via the communication device 309 instead of or in addition to outputting the information from the presentation device 310. The communication terminal 140 that has received the information to be presented can output the received information to be presented via an application of the communication terminal 140, for example. In order to implement such presentation, for example, the user may pair his/her communication terminal 140 with the mobile body 100 when starting to use the mobile body 100, or may set the communication terminal 140 to be able to communicate with the mobile body 100 via a network. An input device 311 includes, for example, a touch panel, and may be configured integrally with the monitor 220. The input device 311 receives an operation input from the user via the touch panel.

A user authentication unit 312 includes a vein sensor that authenticates the user in a non-contact manner, and extracts a feature amount of the vein of the palm of the user to identify the user when the user holds the palm of the hand over the bottom surface portion 232 of the sensor box 230. Whether or not the extracted feature amount matches a feature amount of the vein registered at the start of use of the mobile body 100 is determined, and in a case where the feature amounts match, it is determined that the user is the user himself/herself registered at the start of use.

The control unit 301 implements functions of a user identification unit 321, a detection information processing unit 322, a voice information processing unit 323, and a mode control unit 324 by executing the program stored in the memory 303 or the storage device 308.

The detection information processing unit 322 recognizes an object (including a specific person (user) who uses the mobile body) existing around the mobile body 100 based on the information input from the detection unit 306. The detection information processing unit 322 includes a machine learning model that processes sensor information including an image, and the trained machine learning model executes processing of an inference stage. The machine learning model of the detection information processing unit 322 performs processing of recognizing an object from the sensor information by performing computation of a deep learning algorithm using a deep neural network (DNN), for example. The object may include a user, another person, a signboard, a sign, equipment, building components such as a window and an entrance, a road, a mobile body, a two-wheeled vehicle, and the like included in the image. In addition, the machine learning model of the detection information processing unit 322 can recognize the face of the person, the gesture of the person, and the like included in image information. In the present embodiment, a case where the mobile body 100 processes the sensor information will be described as an example, but sensor information processing may be executed by an external server (not illustrated), and a recognition result may be received from the server.

Furthermore, the detection information processing unit 322 recognizes a state such as the position, speed, or acceleration of the object. The position of the object may be recognized as, for example, a relative position in a coordinate system of the mobile body 100, and then may be converted into an absolute position in a coordinate system used in the map information as necessary. Furthermore, the detection information processing unit 322 calculates a predicted position of a surrounding object by behavior prediction using a machine learning model (for example, a deep learning algorithm) based on a result of recognizing the current position of the object. For example, the predicted position of the object is a predicted position of the object at each future time of the current time t+Δt*n (n=1, . . . , 3). Here, if the number of n is increased, a prediction period becomes longer, and if n is decreased, the prediction period becomes shorter. A known method can be used for generation of a traveling trajectory of the mobile body using object behavior prediction. For example, the traveling trajectory can be generated by evaluating the predicted position of the surrounding object and a risk potential indicating the degree of interference between the mobile body 100 and the object.

The user identification unit 321 continuously determines whether or not the user can be detected from the sensor information. For example, in a case where the user cannot be detected for a predetermined time from the last detection of the user, it is determined that the user is lost. Further, in a case where the user approaches the mobile body 100 again, it is determined that the user is detected again from the sensor information.

The voice information processing unit 323 generates utterance information according to a positional relationship between the mobile body 100 and an object (for example, the user or another person) around the mobile body. The voice information processing unit 323 includes a machine learning model that processes voice information, and executes processing of an inference stage of the machine learning model. The machine learning model of the voice information processing unit 323 recognizes utterance content of the user or generates utterance information for a person around the mobile body 100 by performing, for example, computation of a deep learning algorithm using a deep neural network (DNN). Different machine learning algorithms may be used for the recognition of the utterance content of the user and the generation of the utterance information.

In the recognition of the utterance content of the user, for example, in a case where the utterance of the user indicates a place, a place name or the like included in the utterance information may be identified. In the recognition of the utterance content of the user, for example, a place name, a name of a landmark such as a building, a store name, an object name, and the like included in the utterance information are recognized. The DNN is trained by performing processing of a learning stage, and recognition processing (processing of the inference stage) for the utterance information can be performed by inputting the utterance information to the trained DNN. Note that, in the present embodiment, a case where the mobile body 100 executes voice recognition processing will be described as an example, but the voice recognition processing may be executed by an external server (not illustrated), and a recognition result may be received from the server.

The mode control unit 324 executes processing related to state control to be described later and processing of each control mode (for example, a follow mode, a guide mode, or the like) to be described later, and causes the mobile body to travel according to the characteristics of the control mode.

<Configuration of Information Processing Device>

Next, a configuration of the management server 120 as an example of the information processing device according to the present embodiment will be described with reference to FIG. 3B. The management server 120 includes one or more server devices. Note that the respective functional blocks to be described may be integrated together or separated from each other, and a function to be described may be implemented by another block. In addition, a functional block described as hardware may be implemented by software, and vice versa.

A control unit 351 includes one or more processors 352 represented by a CPU and a memory 353 which is a storage device such as a semiconductor memory. The memory 353 stores a program to be executed by the processor 352, data used for processing in the processor 352, and the like. The control unit 351 develops a program stored in the memory 353 or a storage unit 356 in the memory 353 and executes the program by the processor to control the operation of each unit in the control unit 351 and control the operation of each unit of the management server 120.

A power supply unit 354 is a power supply that supplies power to each unit of the management server 120. A communication unit 355 includes a communication circuit that communicates with the communication terminal 140 and the mobile body 100 via the network 130. The storage unit 356 includes, for example, a nonvolatile storage medium such as a semiconductor memory, and stores setting values and programs necessary for the operation of the management server 120. The storage unit 356 stores information regarding the mobile body received from a plurality of mobile bodies via the communication unit 355. The information regarding the mobile body includes, for example, data regarding the motion of the mobile body, data regarding the remaining battery level, the position of the mobile body, data of the current control mode, and the like.

A mobile body data acquisition unit 371 acquires the information regarding the mobile body from each of the plurality of mobile bodies and stores the information in the storage unit 356. The mobile body data acquisition unit 371 stores information for identifying the mobile body in association with the information regarding the mobile body.

A reservation control unit 372 takes a reservation for using the mobile body 100 at a designated point from the communication terminal 140. The reservation control unit 372 specifies the mobile body 100 in an available state such as an idle state to be described later among the mobile bodies 100 existing in the vicinity of the designated point in position information of each mobile body 100. The reservation control unit 372 sets a reservation including the designated position for the specified mobile body 100. For example, the reservation is periodically inquired by the mobile body 100, and when the reservation is set, the mobile body 100 sets the control mode to a reserved state and moves to the designated point.

The reservation control unit 372 receives a request for canceling the set reservation from the communication terminal 140. In a case where the request for canceling the reservation is received, information regarding cancellation of the reservation is transmitted to the mobile body 100, and the control mode of the mobile body 100 is changed to a wandering mode.

In a case where there are a plurality of stations (to be separately described later) in which the mobile body 100 can be charged in the facility, a mobile body arrangement unit 373 moves the mobile body 100 between the plurality of stations. The mobile body arrangement unit 373 predicts a demand of the mobile body for each station (for example, a demand ratio between stations) according to the number of persons in the vicinity of each station for the movement of the mobile body 100, and adjusts the number of mobile bodies 100 staying in each station according to the prediction result. Alternatively, in a case where a certain number of mobile bodies 100 are periodically moved in the wandering mode between the stations, the mobile body arrangement unit 373 calculates the density of users in an area associated with the station, and decreases the number of mobile bodies 100 traveling in the wandering mode in an area with a higher density.

A management information generation unit 374 generates a management screen for a system administrator to confirm an operating state of the mobile body 100, provide the position of the mobile body 100 in response to an inquiry from a user who searches for the mobile body 100, or distribute a task to the mobile body 100 (for example, manually set a reservation). The management information generation unit 374 uses various data of the mobile body 100 acquired by the mobile body data acquisition unit 371 or stored in the storage unit 356 to display information such as the remaining amount of power, the position information, and the current control mode on the management screen.

<Configuration of Communication Terminal>

The communication terminal 140 according to the present embodiment includes a processor and a memory. In accordance with a user input that is input via an operation unit, a point to meet the called mobile body 100 is designated. The communication terminal 140 includes, for example, a communication device including a communication circuit and the like, and transmits and receives necessary data to and from the management server 120 via mobile communication such as LTE.

<State Transition of Mobile Body and Usage Example of Movement Assistance System>

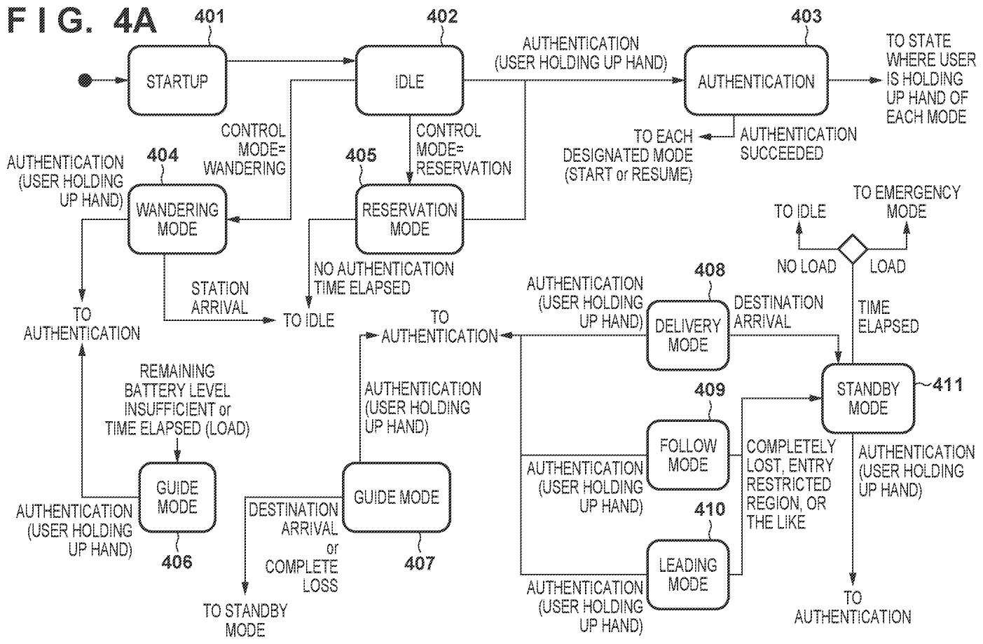

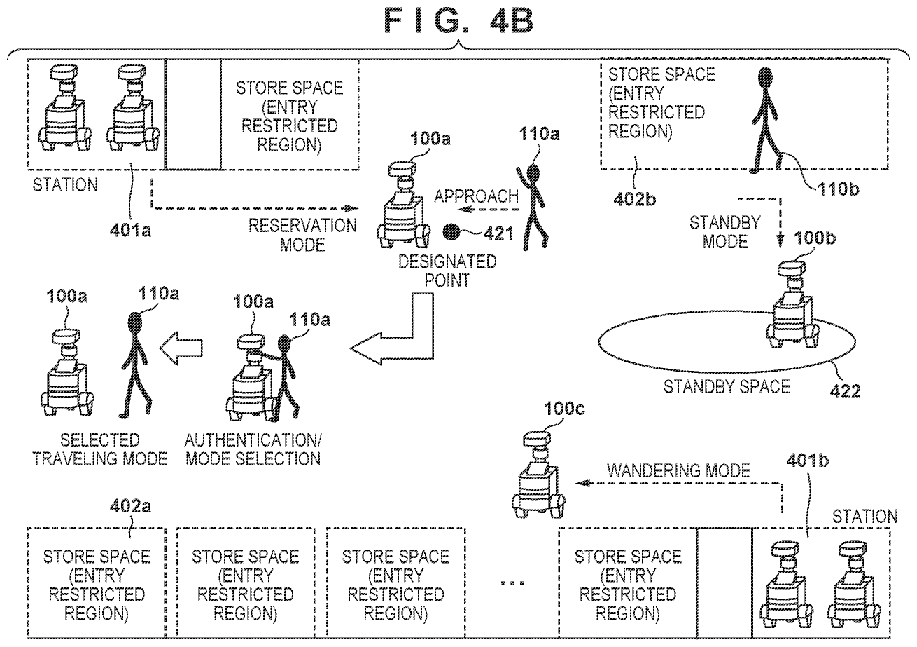

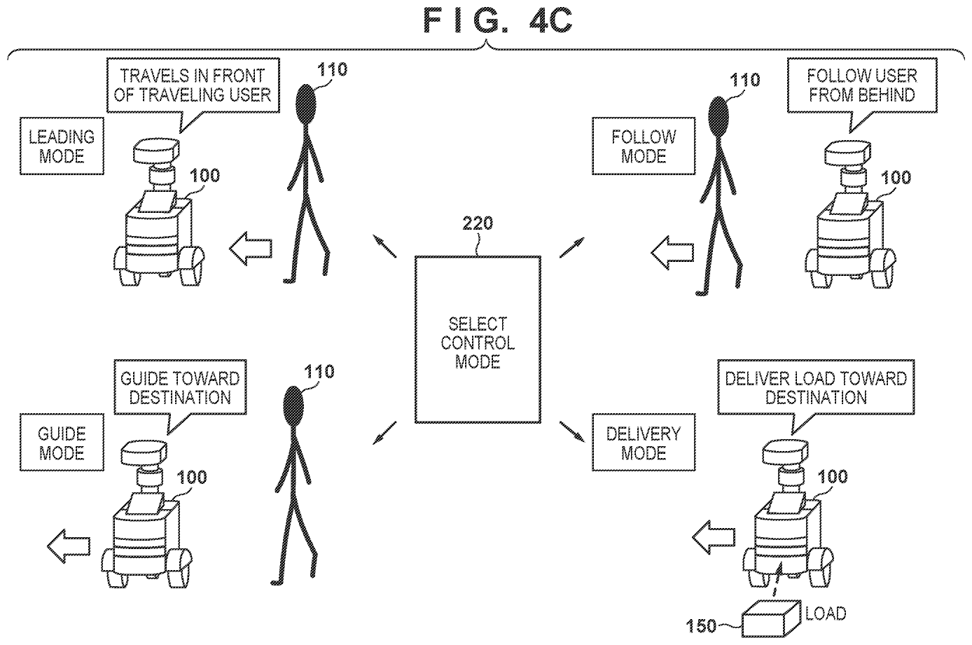

Next, state transition of the mobile body 100 and a usage example of the movement assistance system will be described with reference to FIGS. 4A, 4B, and 4C. FIG. 4A illustrates state transition of the mobile body 100. Note that control of the state transition described in FIG. 4A can be implemented by the processor 302 executing a program. For example, the mobile body 100 is arranged in the station and becomes operable by being powered on.

First, a control state of the mobile body 100 is started from startup 401. In the startup 401, the mobile body 100 downloads, from the management server 120, data such as a traveling route, map information including an area definition (including information regarding a region where entry is restricted), and a list of registrants. Furthermore, the mobile body 100 reads the above-described machine learning model and the like. Thereafter, the state of the mobile body 100 transitions to idle 402.

The idle 402 is a state of communicating with the management server 120 periodically, for example, every 10 seconds to confirm whether or not a reservation is set or waiting for an instruction to transition to the wandering mode. In addition, the mobile body 100 is stopped in the idle 402. In a case where the reservation is set, the mobile body 100 transitions to a reservation mode 405. In a case where the instruction to transition to a wandering mode 404 is received from the management server 120 in the idle 402, the mobile body 100 transitions to the wandering mode 404. The wandering mode 404 is a mode for moving between the stations. The mobile body 100 determines a traveling route to a station as a destination and performs autonomous traveling. Furthermore, in the idle 402, when the user holds the palm of the hand over the bottom surface portion 232 of the sensor box 230, the mobile body 100 transitions to authentication 403, and performs authentication to register the user or determine whether or not the user is the same person as the registered user. In the authentication 403, when the registration of the user is completed or the authentication of the user is successful, a traveling mode (the guide mode, a leading mode, or the like) designated by the user is started or the traveling mode before the transition to the authentication 403 is resumed. In the reservation mode, in a case where a predetermined time has elapsed without the user appearing after the mobile body 100 arrives at the designated point, for example, the mobile body transitions to the idle 402. The mobile body 100 may transition to the wandering mode 404 in order to return to the station.

FIG. 4B illustrates an example in which this movement assistance system is implemented in a large commercial facility. In the facility, a plurality of stations 401a and 401b in which the mobile body 100 can be charged are installed, and the plurality of mobile bodies are arranged in the station.

For example, when the mobile body 100a arranged in the station 401a transitions to the reservation mode, the mobile body 100a moves to a point 421 designated by the reservation. When a person approaches the mobile body 100a, the mobile body 100a is stopped and performs user authentication of a specific person (a user 110a) by vein authentication where the person's hand is held over the bottom surface portion 232 of the sensor box 230. Since there is no vein information of the palm of the user 110a at the start of use of the mobile body 100a, the mobile body 100a temporarily registers the vein information for the use of the mobile body 100a. Alternatively, the vein information can be registered in advance on a server side, and in a case where the user has registered his/her own vein information in the server, the mobile body 100a may perform user authentication based on the vein information registered in the server. Furthermore, the mobile body 100a may scan the vein information and transmit the vein information to the server, and the user authentication itself may be performed on the server side. The user 110a selects a control mode that the user wants to use via the touch panel (the input device 311). Thereafter, the mobile body 100a travels in the vicinity of the user 110a in the selected mode.

In addition, in the example illustrated in FIG. 4B, a mobile body 100c is set to the wandering mode. Therefore, the mobile body 100c travels to move between the stations. Note that the mobile body 100 traveling in the wandering mode accepts user authentication (user registration) where the person's hand is held over the bottom surface portion 232 of the sensor box 230. The user 110 can use the mobile body 100 in the wandering mode that happens to pass nearby. In this manner, the mobile body 100 can increase use opportunities by people. In addition, the mobile body 100 makes the traveling speed of the mobile body in the wandering mode lower than the traveling speeds in other control modes, so that the user can more easily access the mobile body 100 in the wandering mode.

FIG. 4A is referred to again. In the authentication 403, when the registration is completed or the authentication is successful, the operation of each designated mode is started or resumed. The transition of the control mode is made in accordance with, for example, a mode selected by the user through the touch panel (the input device 311), and the control mode transitions to one of a guide mode 407, a delivery mode 408, a follow mode 409, and a leading mode 410.

Furthermore, in a case where the mobile body 100 arrives at a destination (in a mode in which the destination is set) or the user cannot be detected for a predetermined time or more (in a mode of traveling in parallel with the user) while traveling in these modes, the control mode transitions to a standby mode 411. In addition, the mobile body 100 transitions to the standby mode 411 also in a case where the user 110 moves to a region where the entry of the mobile body is restricted (such as a store region). The standby mode 411 is a mode of standing by at a specific point until the traveling mode in which the mobile body 100 travels in the vicinity of the user 110 is started or resumed.

For example, in the example illustrated in FIG. 4B, in a case where a user 110b enters a store space 402b (a region where the entry of the mobile body 100 is restricted) when the mobile body 100b travels in the vicinity of the user 110b, the mobile body 100b transitions to the standby mode and moves to a specific point (a standby space 422) to stand by. Thereafter, when the user 110b visits the standby space 422 and the authentication in the mobile body 100b is successful, the user 110b can set a new mode or resume the previous traveling mode. In a case where a predetermined time has elapsed from the previous user authentication without performing user authentication, the control mode may shift to the wandering mode to move to the station.

In a case where the remaining battery level of the mobile body 100 is equal to or less than a certain value, the control mode shifts from one of the modes to an emergency mode. An emergency mode 406 is a mode in which the mobile body 100 returns to the station. Even in a case where a predetermined time has elapsed with a load being placed in the housing, the mobile body 100 shifts to the emergency mode in order to move to the station (or a predetermined place where a lost article is deposited).

Next, an overview of the leading mode 410, the guide mode 407, the follow mode 409, and the delivery mode 408 will be described with reference to FIG. 4C.

In the leading mode 410, the mobile body 100 travels in front of the user 110 while adjusting the traveling speed in such a way as to keep an appropriate distance from the user 110 based on behavior prediction for the user 110. In the leading mode, the mobile body 100 does not grasp the destination of the user. The mobile body 100 autonomously performs collision avoidance in a crowd. The mobile body 100 may recognize a gesture of the user and receive a direction instruction by the gesture. The mobile body 100 may adjust the traveling direction according to the recognized gesture.

In the follow mode 409, the mobile body 100 follows the user 110 behind the user 110. Also in this mode, the mobile body 100 does not grasp the destination of the user. The mobile body 100 autonomously performs collision avoidance in a crowd.

In the guide mode 407, the mobile body 100 travels in front of the user 110 according to a traveling route to a destination designated by the user 110. The mobile body 100 first sets the traveling speed of the mobile body to a predetermined speed, and then adjusts the traveling speed according to a change in distance to the user 110. The mobile body 100 autonomously performs collision avoidance in a crowd. The delivery mode 408 is a mode in which a load 150 is carried to a designated destination, and the mobile body 100 travels alone.

<Characteristics of Each Control Mode>

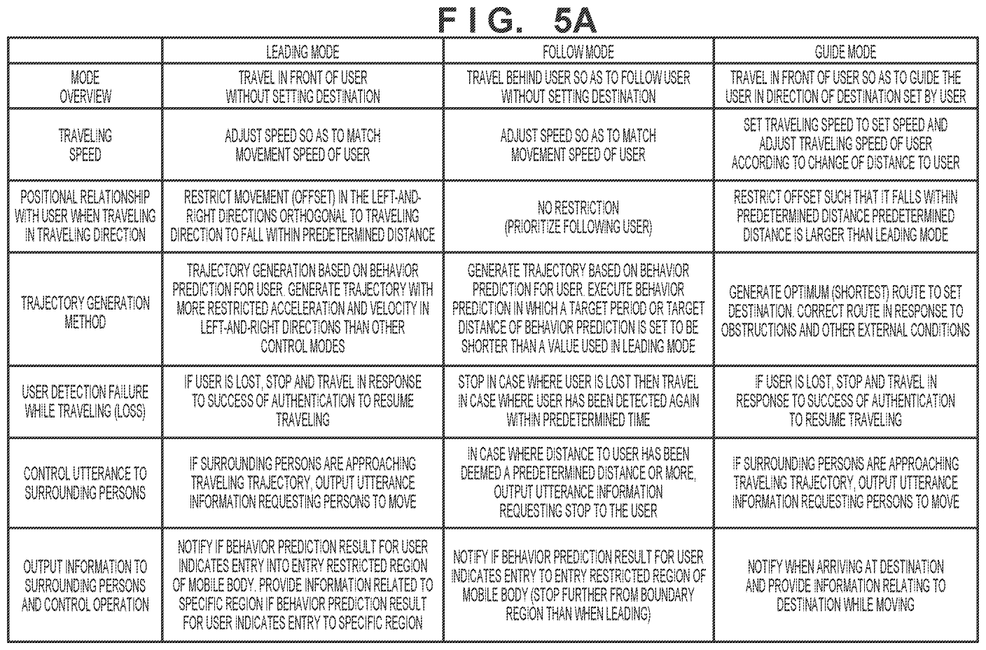

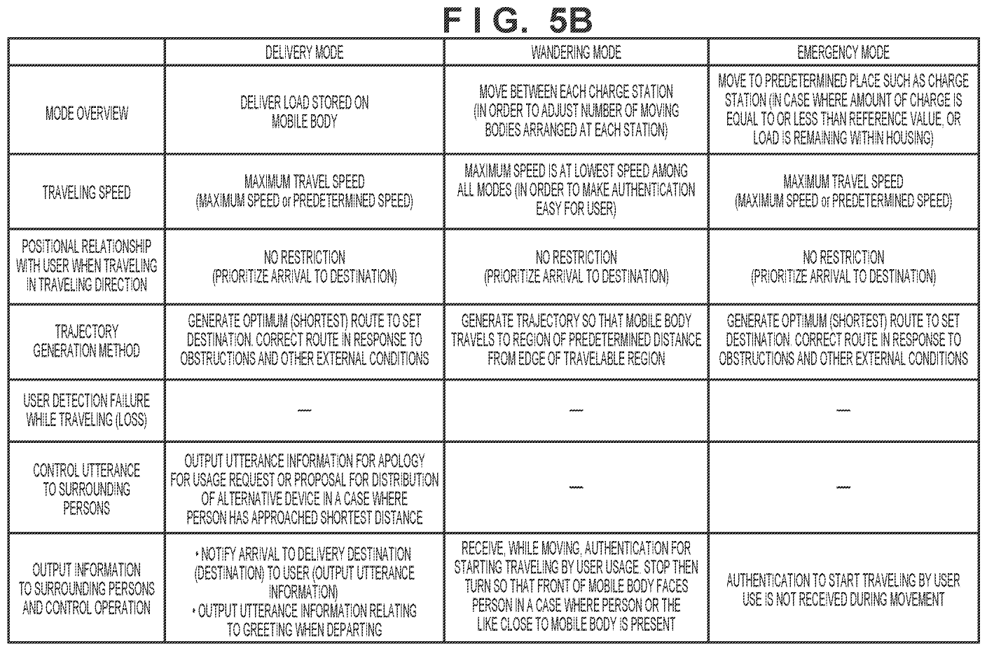

FIGS. 5A and 5B illustrate characteristics of the control mode according to the present embodiment, that is, the leading mode, the follow mode, the guide mode, the delivery mode, the wandering mode, and the emergency mode in a table form. As an example, each mode is characterized by attributes such as the traveling speed of the mobile body, generation of the traveling trajectory of the mobile body, the positional relationship between the user and the mobile body, control of utterance to a person around the mobile body, and a form of presentation of information to a person around the mobile body. In the leading mode, the follow mode, and the guide mode illustrated in FIG. 5A, the mobile body travels in the vicinity of the user. On the other hand, in the delivery mode, the wandering mode, and the emergency mode illustrated in FIG. 5B, the mobile body travels alone. What should be particularly described in the description of FIGS. 5A and 5B is shown below.

As for the traveling speed of the mobile body, in the leading mode and the follow mode, the mobile body 100 controls the traveling speed of the mobile body in such a way that the distance to the user 110 is kept within a certain range, that is, the traveling speed matches a movement speed of the user. On the other hand, in the guide mode, the traveling speed of the mobile body is set to a predetermined speed, and then the traveling speed is adjusted according to a change in distance to the user 110.

In the positional relationship between the user and the mobile body, movement (offset) in the left-and-right direction orthogonal to the traveling direction is limited in the leading mode and the guide mode. This is to prevent the user walking behind from having difficulty in walking when the mobile body 100 traveling in front of the user wobbles in the left-and-right direction. The limit of the offset in the leading mode is larger than the limit of the offset in the guide mode (a movement width in the left-and-right direction within a predetermined time is small).

As for the traveling trajectory based on the behavior prediction for the user, the mobile body 100 generates the traveling trajectory of the mobile body in which an acceleration and speed in the left-and-right direction orthogonal to the traveling direction are more limited as compared with other control modes, in the leading mode. For example, in the leading mode, the acceleration and speed in the left-and-right direction orthogonal to the traveling direction are limited more than those in the guide mode based on the traveling route toward the designated destination. Since the vehicle does not wobble quickly in the left-and-right direction, a walking distance of the user is short, and it is possible to take a traveling trajectory in which the surrounding pedestrians and the like are likely to give way as much as possible. The user in the leading mode is assumed to be an elderly person or a person who has mobility difficulties, and walking of such a user can be assisted by suppressing the wobbling in the left-and-right direction.

In the follow mode, a target period or target distance of the behavior prediction is set to be shorter than a value used in the leading mode, and the traveling trajectory of the mobile body 100 based on the behavior prediction of the user is generated. In the follow mode, since the mobile body travels behind the user, the prediction period or prediction distance can be shorter than that in the leading mode in which the mobile body travels in front of the user, and the amount of computation related to the behavior prediction can be reduced.

In a case of a user detection failure (loss) during traveling, the mobile body 100 is stopped when temporarily failing to detect the user in the leading mode and the guide mode, and requires user authentication again. On the other hand, in the follow mode, for example, in a case where the user walking in front of the mobile body is detected again from the sensor information, the traveling is resumed without performing the user authentication.

In the follow mode, in the control of utterance to a person around the mobile body, utterance information for requesting the user to stop is output when the distance between the mobile body and the user becomes a predetermined first distance or more. As a result, it is possible to make the user whose field of view does not include the mobile body be aware of the delay of the mobile body. In the leading mode and the guide mode, since the mobile body travels in front of the user, it is not necessary to output such utterance information. In the leading mode and the guide mode, when a person exists on or near a movement trajectory of the mobile body traveling in front of the user, the mobile body 100 outputs utterance information for requesting the person to move.

In the presentation of information to a person around the mobile body, in a case where the leading mode is set, the mobile body 100 outputs information regarding a specific store to the user as an utterance or displays the information on a display device when a behavior prediction result for the user indicates that the user enters a region of the specific store.

Furthermore, in a case where the leading mode is set, in the presentation of information to the person around the mobile body, the mobile body 100 is stopped at a position separated from an entry restricted region by a predetermined second distance when the behavior prediction result for the user indicates entry into the entry restricted region, and outputs utterance information for requesting the user to stop.

On the other hand, in the follow mode, the mobile body 100 is stopped at a position separated from the entry restricted region by a predetermined third distance that is longer than the second distance when the behavior prediction result for the user indicates entry into the entry restricted region, and outputs utterance information for requesting the user to stop.

Next, the delivery mode, the wandering mode, and the emergency mode will be described with reference to FIG. 5B. As for the traveling speed of the mobile body, in the wandering mode, the mobile body 100 makes the traveling speed of the mobile body in the wandering mode lower than the traveling speeds in other control modes. As a result, the user can more easily access the mobile body 100.

As for the trajectory generation, in the delivery mode and the emergency mode, an optimum route to a destination can be set based on the map information. In the wandering mode, the mobile body travels in a region separated by a certain distance from an end of a travelable region for the mobile body in such a way as not to disturb movement of a passerby or another mobile body as much as possible.

The mobile body 100 accepts user authentication while traveling in the wandering mode. At this time, for example, in a case where a person approaches (in a case where a person approaching the mobile body is recognized within a predetermined distance, or it is determined that a predicted movement trajectory of a person approaching the mobile body intersects with a movement trajectory of the mobile body) during the traveling of the mobile body in the wandering mode, the mobile body may be stopped in such a way that a front surface of the mobile body faces the approaching person. Meanwhile, the mobile body 100 does not accept user authentication while traveling in the reservation mode and the emergency mode because the mobile body 100 is moving toward a point designated by the reservation or the remaining amount of power is a certain level or less. When traveling in the reservation mode and the emergency mode, the mobile body 100 displays, on the presentation device 310, a state in which the user authentication is not accepted or the mobile body cannot be used by the user. In this way, the user can easily grasp which traveling mobile body can be used.

<Processing Related to State Control>

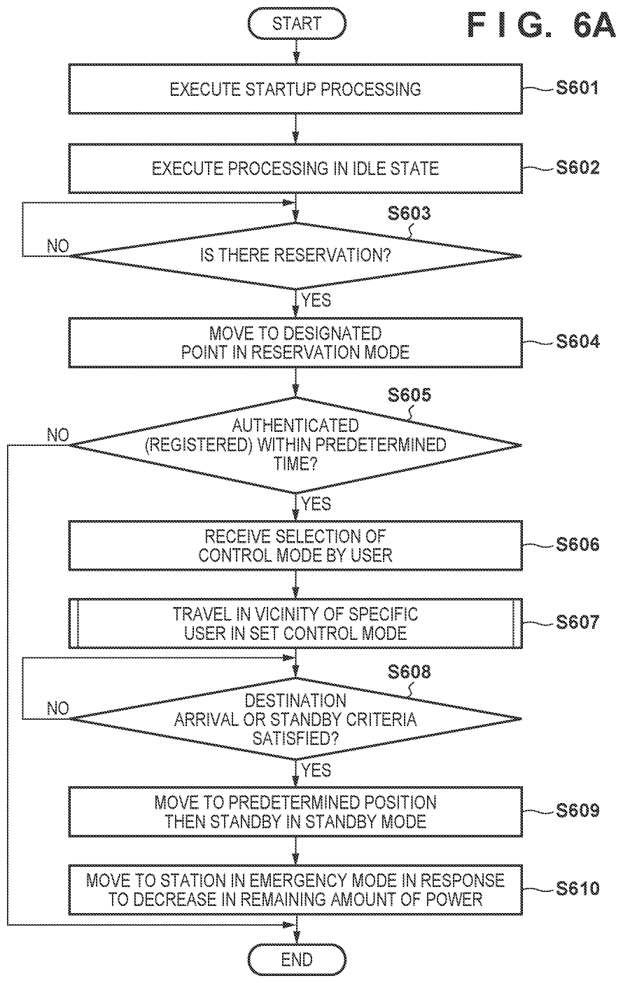

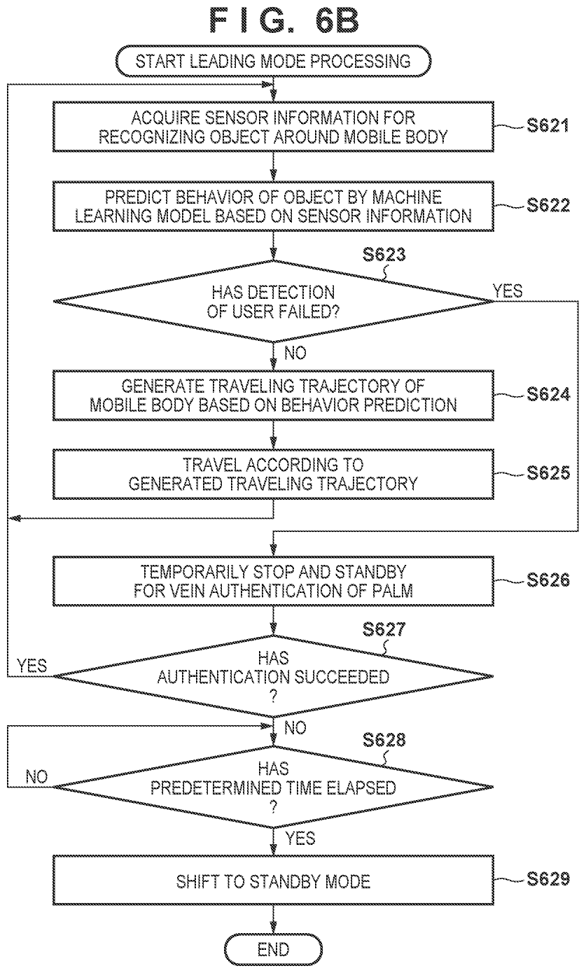

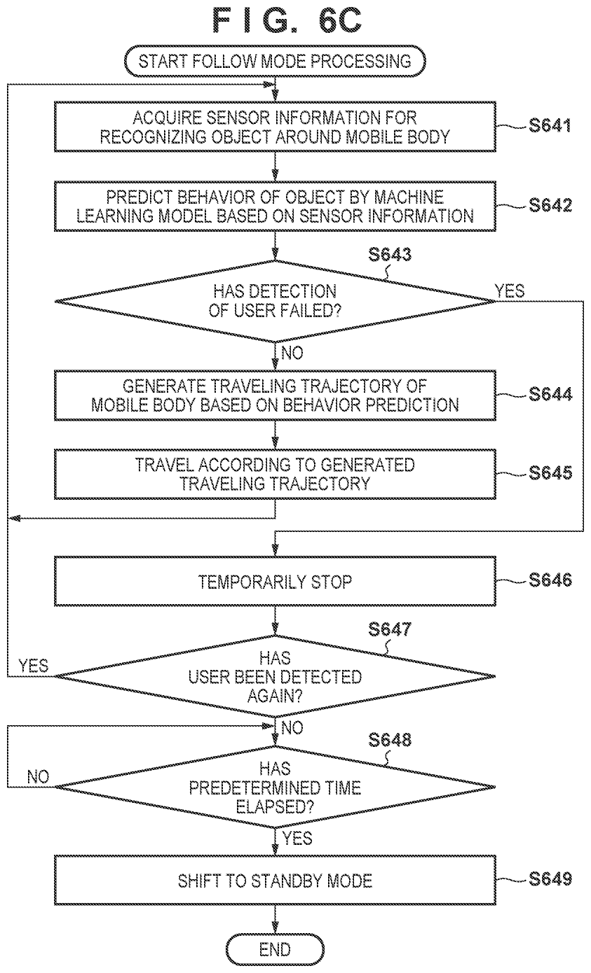

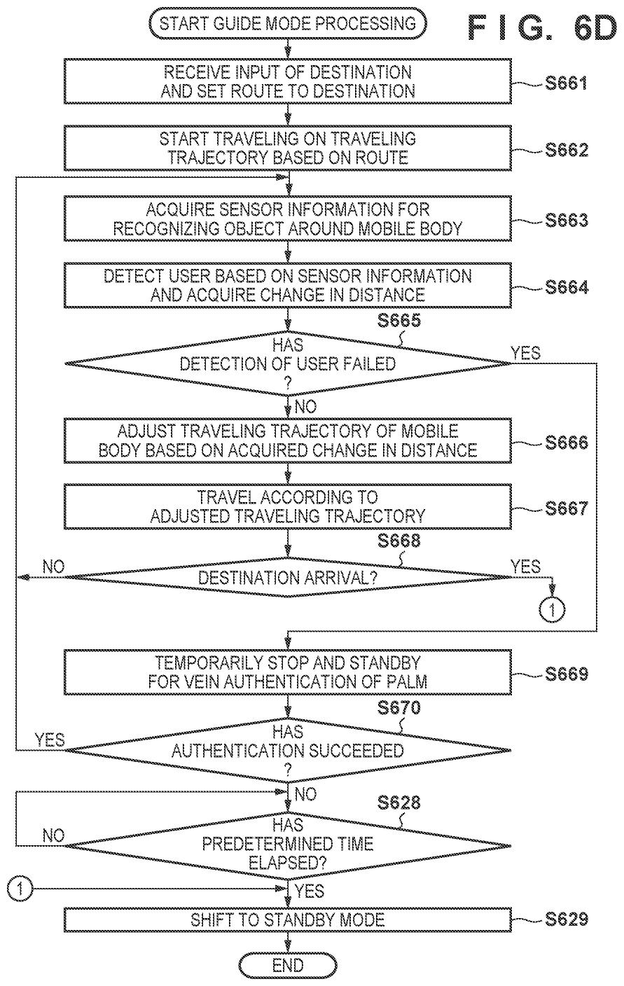

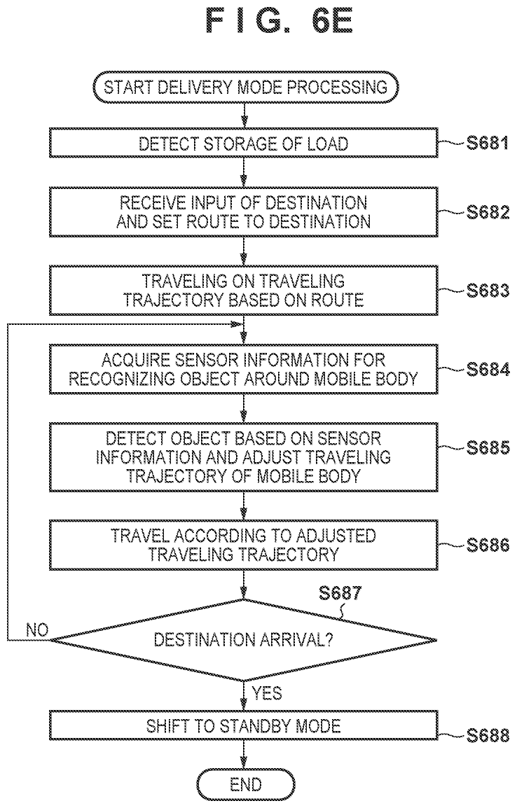

Next, an operation of processing related to state control of the mobile body will be described with reference to FIG. 6A. This processing is implemented in a manner in which the processor 302 of the control unit 301 of the mobile body executes a program stored in the memory 303 or the storage device 308, and each unit included in the control unit 301 operates. In the following description, an operation subject of this processing will be described as the control unit 301, but each unit of the control unit 301 actually executes the processing.

In S601, the control unit 301 executes startup processing. The startup processing is as described above with reference to FIG. 4A. In S602, the control unit 301 executes processing in the idle state. For example, the control unit 301 periodically communicates with the management server 120 to confirm whether or not a reservation is set. In S603, the control unit 301 determines whether or not there is a reservation based on a response of the management server 120, and proceeds to S604 in a case where there is a reservation, and repeats S603 in a case where there is no reservation.

In S604, the control unit 301 transitions to the reservation mode and acquires information regarding the reservation from the management server 120. The information regarding the reservation includes, for example, a position of a designated point expressed in a coordinate system of a map. The information regarding the reservation may further include a use start time for the mobile body 100. The mobile body 100 determines an optimum route to the designated point by using information regarding the designated point and the map information including the traveling route and the area definition. The control unit 301 moves to the designated point while controlling traveling of the own device along the determined optimum route.

In S605, when arriving at the designated point, the control unit 301 determines whether or not registration of authentication is performed, for example, within a predetermined time after the arrival. The authentication is, for example, registration of the vein information of the palm of the user. In a case where the user holds the palm of the hand over the bottom surface portion 232 of the sensor box 230 within a predetermined time to register the vein information, the control unit 301 proceeds to S606, and otherwise, ends the processing. Since there is no vein information of the palm of the user at the start of use of the mobile body 100, the mobile body 100a temporarily registers the vein information for the use of the mobile body 100a. The information to be registered is stored in, for example, the storage device 308, and may be deleted at a predetermined timing, for example, a timing when an operation to end the use by the user is received or a change in date and time is made, or at a timing of shutdown. Furthermore, as described above, in the user authentication, the vein information registered in advance on the server side may be used, or the user authentication may be performed on the server side.

In S606, the control unit 301 receives selection of the control mode to be used by the user via the touch panel (the input device 311). In S607, the control unit 301 transitions to the selected control mode, and travels in the vicinity of the user in the selected mode. The operation in each mode will be described later.

As a result of the mobile body 100 continuing to travel in the vicinity of the user, in S608, the control unit 301 determines whether or not the mobile body has arrived at the destination or whether or not a predetermined criterion of standby has been satisfied. In a case where an affirmative determination is made, the control unit 301 proceeds to S609, and otherwise, the processing is repeated. In a case where the mobile body 100 operates in the guide mode, the mobile body 100 can arrive at the destination. Furthermore, as an example, in a case where the user approaches a set of persons having a predetermined density or more in such a way that a distance to the set of persons is a predetermined distance, for example, the control unit 301 determines that movement of the user satisfies a predetermined criterion for the mobile body to wait while being away from the user. That is, in a case where the user approaches a crowd of a predetermined number or more of persons in such a way that a distance to the crowd is a predetermined distance, it is determined that the standby criterion is satisfied in order to prevent collision between the mobile body 100 and the persons. Alternatively, in a case where the user approaches a set of persons having a predetermined density or more in such a way that a distance to the set of persons is a predetermined distance and/or reliability of the predicted trajectory of the user is equal to or less than a threshold, it may be determined that the movement of the user satisfies the predetermined criterion. Furthermore, in a case where utterance information including an instruction to stand by is received from the user, it may be determined that the movement of the mobile body satisfies a predetermined criterion. In addition, even in a case where the mobile body and the user are separated from each other by a predetermined distance or more when the mobile body 100 travels in the guide mode, it may be determined that the movement of the user satisfies the predetermined criterion for the mobile body to wait while being away from the user. Furthermore, in a case where the user cannot be detected from the sensor information for a predetermined time (a time corresponding to complete loss of the user) from the last detection, the control mode of the mobile body shifts to the standby mode.

In S609, the control unit 301 shifts to the standby mode, searches for a standby space from map data, and calculates a traveling route to the standby space. The control unit 301 moves to the standby space along the traveling route. When arriving at the standby space, the control unit 301 may stand by in such a way that the front surface of the mobile body faces a point away from the user (a point where the mobile body has entered the standby mode). The control unit 301 may shift from the standby mode to the wandering mode and move to the station when a predetermined time has elapsed from the start of standby in the standby space.

In S610, the control unit 301 then transitions to the emergency mode and moves to the station in response to a decrease in remaining amount of power (that is, in response to the remaining amount of power equal to or less than a threshold). In a case where the remaining amount of power of the mobile body is equal to or less than the threshold, when there is no station in a movable range based on the remaining amount of power, the control unit 301 may shift to the standby mode. Thereafter, the control unit 301 ends the processing.

<Processing Related to Leading Mode of Mobile Body>

Next, processing related to the leading mode will be described with reference to FIG. 6B. This processing is started when the leading mode is selected in S606 of FIG. 6A and the leading mode is activated in S607. Accordingly, this processing is implemented in a manner in which the processor 302 of the control unit 301 of the mobile body executes a program stored in the memory 303 or the storage device 308, and each unit included in the control unit 301 operates.

In S621, the control unit 301 acquires sensor information for recognizing an object around the mobile body. In S622, the control unit 301 causes the above-described detection information processing unit 322 to perform object behavior prediction by using the machine learning model based on the sensor information. In S623, the control unit 301 determines whether or not user detection has failed in the processing in the detection information processing unit 322 over a predetermined period, and proceeds to S626 in a case where the detection has failed, and proceeds to S624 in a case where the detection has not failed.

In S624, the control unit 301 generates a traveling trajectory of the mobile body based on the behavior prediction. In generating a traveling trajectory of the mobile body, a traveling trajectory for traveling in front of the user is generated in such a way as to have a substantially constant positional relationship with a predicted position of the user. In the leading mode, the traveling trajectory of the mobile body is generated by applying a constraint in such a way that an acceleration and speed in a direction orthogonal to the traveling direction are limited more than those in other control modes. In S625, the control unit 301 travels in the facility according to the generated traveling trajectory.

In S626, in a case where the user cannot be detected for a predetermined period, the control unit 301 is temporarily stopped and waits for user authentication. In S627, when the user approaches the mobile body 100 again and performs authentication, in a case where the authentication is successful, the control unit 301 returns to S621 again and resume traveling.

In a case where the user cannot be detected over the predetermined period, the control unit 301 may output utterance information for calling for the user to return to the position of the mobile body. Furthermore, in a case where a predetermined time has elapsed from the output of the utterance information without detecting the user from the sensor information, the control unit 301 may proceed to S629, or change the control mode of the mobile body to the wandering mode.

In S628, the control unit 301 determines whether or not a predetermined time for transitioning to the standby mode has elapsed without successful user authentication after failing to detect the user, and in a case there the predetermined has elapsed, shifting to the standby mode is made in S629. Then, this processing ends.

<Processing Related to Follow Mode of Mobile Body>

Next, processing related to the follow mode will be described with reference to FIG. 6C. This processing is started when the follow mode is selected in S606 of FIG. 6A and the follow mode is activated in S607. Accordingly, this processing is implemented in a manner in which the processor 302 of the control unit 301 of the mobile body executes a program stored in the memory 303 or the storage device 308, and each unit included in the control unit 301 operates.

In S641, the control unit 301 acquires sensor information for recognizing an object around the mobile body. In S642, the control unit 301 causes the above-described detection information processing unit 322 to perform object behavior prediction by using the machine learning model based on the sensor information. In S643, the control unit 301 determines whether or not user detection has failed in the processing in the detection information processing unit 322 over a predetermined period, and proceeds to S646 in a case where the detection has failed, and proceeds to S644 in a case where the detection has not failed.

In S644, the control unit 301 generates a traveling trajectory of the mobile body based on the behavior prediction. In generating a traveling trajectory of the mobile body, a traveling trajectory for traveling behind the user is generated in such a way as to have a substantially constant positional relationship with the predicted position of the user. In the follow mode, a target period or target distance of the behavior prediction is set to be shorter than a value used in the leading mode, and the traveling trajectory of the mobile body 100 based on the behavior prediction of the user is generated. In S645, the control unit 301 travels in the facility according to the generated traveling trajectory.

In S646, in a case where the user cannot be detected for a predetermined period, the control unit 301 is temporarily stopped. At this time, recognition of surrounding objects continues. In a case where the user approaching the mobile body 100 is detected again in S647, the processing returns to S641 again, and the traveling is resumed.

In S648, the control unit 301 determines whether or not a predetermined time for transitioning to the standby mode has elapsed without detecting the user again after failing to detect the user again, and in a case there the predetermined has elapsed, shifting to the standby mode is made in S649. Then, this processing ends.

<Processing Related to Guide Mode of Mobile Body>

Next, processing related to the guide mode will be described with reference to FIG. 6D. This processing is started when the guide mode is selected in S606 of FIG. 6A and the guide mode is activated in S607. Accordingly, this processing is implemented in a manner in which the processor 302 of the control unit 301 of the mobile body executes a program stored in the memory 303 or the storage device 308, and each unit included in the control unit 301 operates.

In S661, the control unit 301 receives an input of a destination and sets a route to the destination. In S662, the control unit 301 starts traveling on a traveling trajectory based on the route. At this time, a predetermined speed is set as the traveling speed in the guide mode. In S663, the sensor information for recognizing an object around the mobile body is acquired. In S664, the control unit 301 causes the above-described detection information processing unit 322 to acquire the position of the object based on the sensor information. As a result, the control unit 301 can acquire a change in distance to the user.

In S665, the control unit 301 determines whether or not user detection has failed in the processing in the detection information processing unit 322 over a predetermined period, and proceeds to S666 in a case where the detection has failed, and proceeds to S664 in a case where the detection has not failed.

In S666, the control unit 301 adjusts the traveling trajectory (traveling speed) of the mobile body based on the acquired change in distance. In generating the traveling trajectory of the mobile body, the traveling trajectory of the mobile body is adjusted in such a way that the distance to the user is substantially constant. In S667, the control unit 301 travels in the facility according to the generated traveling trajectory. In S668, the control unit 301 determines whether or not the mobile body has arrived at the destination based on the current position. In a case where it is determined that the mobile body has arrived at the destination, the processing proceeds to S629, and in a case where the mobile body has not arrived at the destination, the processing returns to S663.

In S669, in a case where the user cannot be detected for a predetermined period, the control unit 301 is temporarily stopped and waits for user authentication. In S670, when the user approaches the mobile body 100 again and performs authentication, in a case where the authentication is successful, the control unit 301 returns to S663 again and resume traveling. Hereinafter, similarly to the processing illustrated in FIG. 6B, the processings of S628 and S629 are executed to shift to the standby mode, and this processing ends.

<Processing Related to Delivery Mode of Mobile Body>

Next, processing related to the delivery mode will be described with reference to FIG. 6E. This processing is started when the delivery mode is selected in S606 of FIG. 6A and the delivery mode is activated in S607. Accordingly, this processing is implemented in a manner in which the processor 302 of the control unit 301 of the mobile body executes a program stored in the memory 303 or the storage device 308, and each unit included in the control unit 301 operates.

In S681, the control unit 301 detects storage of a load. In detecting the storage of a load, an increase in weight of the housing may be detected, or closing of the door may be detected. In S682, the control unit 301 receives an input of a destination and sets a route to the destination. In S683, the control unit 301 travels on a traveling trajectory based on the route. In S684, the sensor information for recognizing an object around the mobile body is acquired. In S685, the control unit 301 causes the above-described detection information processing unit 322 to detect an object based on the sensor information. In the delivery mode, since there is no object traveling side by side, the position of the object is simply used for collision avoidance. The control unit 301 adjusts the traveling trajectory of the mobile body according to the position of the object. In S686, the control unit 301 travels along the adjusted traveling trajectory.

In S687, the control unit 301 determines whether or not the mobile body has arrived at the destination based on the current position. In a case where it is determined that the mobile body has arrived at the destination, the processing proceeds to S688, and in a case where the mobile body has not arrived at the destination, the processing returns to S684. In S688, the control unit 301 changes the control mode of the mobile body to the standby mode and ends this processing. The control unit 301 may determine whether or not the destination is within a predetermined distance from a station in which the mobile body 100 can be charged. In a case where the destination is within the predetermined distance from the station, the control unit 301 may shift to the wandering mode in which the mobile body moves to the station without shifting to the standby mode.

As described above, in the above-described embodiment, the mobile body control device acquires the sensor information for recognizing an object around the mobile body, presents predetermined information to a person around the mobile body, and sets one of the plurality of control modes. The mobile body control device further controls traveling of the mobile body and presentation of the predetermined information based on the set control mode and a result of detection of the specific person based on the sensor information. At this time, in the control, the traveling of the mobile body and the presentation of the predetermined information are controlled by making at least one of the traveling speed of the mobile body, the generation of the traveling trajectory of the mobile body, the positional relationship between the specific person and the mobile body, and the form of presentation of the information to the person around the mobile body different for each control mode.

In this way, it is possible to more appropriately assist movement of a person in a site by providing various assistance modes.

Furthermore, in the above-described embodiment, the mobile body control device acquires the sensor information for recognizing an object around the mobile body, sets one of the plurality of control modes, and controls the traveling of the mobile body based on the set control mode and a result of detection of the specific person based on the sensor information. At this time, the plurality of control modes include a plurality of traveling modes of traveling in the vicinity of the specific person when the person is walking and a standby mode of standing by at a specific point until any one of the traveling modes is started or resumed. Furthermore, in the control, the traveling of the mobile body is controlled in such a way that the mobile body travels in the vicinity of the specific person when the person is walking in the plurality of traveling modes, and in a case where it is determined that movement of the specific person or movement of the mobile body satisfies a predetermined criterion for the mobile body to wait while being away from the specific person, the traveling mode shifts from any one of the traveling modes to the standby mode.

By doing so, the mobile body does not have to enter a crowd or a place where the mobile body is not allowed to enter while more appropriately supporting movement of a person in a site, thereby improving safety.

In the above-described embodiment, the mobile body control device acquires the sensor information for recognizing an object around the mobile body, sets one of the plurality of control modes, and controls the traveling of the mobile body based on the set control mode and a result of detection of the specific person based on the sensor information. At this time, in the control, the traveling of the mobile body is controlled in such a way that the mobile body travels in the vicinity of the specific person when the person is walking in a traveling mode of the plurality of control modes, and the plurality of control modes include the reservation mode. Furthermore, in the control, the traveling of the mobile body is controlled in such a way that the mobile body moves to a point designated by the specific person before starting the traveling mode, in the reservation mode.

In this way, it is possible to improve usability when starting to use the mobile body while more appropriately supporting movement of a person in a site.

### Summary of Embodiment

2-1. A mobile body (for example, 100) control device (for example, 300), in the above embodiments, comprising:
one or more processors; and
a memory storing instructions which, when the instructions are executed by the one or more processors, cause the mobile body control device to function as:
an acquisition unit (for example, 306) configured to acquire sensor information for recognizing an object around a mobile body, the sensor information including a captured image obtained by capturing a periphery of the mobile body;
a setting unit (for example, 311 and 301) configured to set one of a plurality of control modes; and
a control unit (for example, 301, 322 and 324) configured to control traveling of the mobile body based on the set control mode and a result of detection of a specific person based on the sensor information,
wherein the plurality of control modes include a plurality of traveling modes of traveling together with the specific person when the person is walking, and a standby mode of standing by at a specific point until any one of the traveling modes is started or resumed,
the control unit controls the traveling of the mobile body in such a way that the mobile body travels together with the specific person when the person is walking in the plurality of traveling modes, and
in a case where it is determined that movement of the specific person or movement of the mobile body satisfies a predetermined criterion for the mobile body to wait while being away from the specific person, the control unit shifts from one of the traveling modes to the standby mode

According to the embodiment, the mobile body does not have to enter a crowd or a place where the mobile body is not allowed to enter while more appropriately supporting movement of a person in a site, thereby improving safety.

2-2. (Movement to Standby Area and Standby)

The mobile body control device, in the above embodiments, wherein in a case where the control mode of the mobile body shifts to the standby mode, the control unit moves from a first point where the shifting to the standby mode is made to the specific point and stands by.

2-3. (Standby in Standby Area)

The mobile body control device, in the above embodiments, wherein the control unit stands by in such a way that a front surface of the mobile body faces the first point when the mobile body arrives at the specific point.

2-4. (Access to Set of Persons Having Predetermined Density)

The mobile body control device, in the above embodiments, wherein in a case where the specific person approaches a set of persons having a predetermined density or more in such a way that a distance to the set of persons is a predetermined distance, the control unit determines that the movement of the specific person satisfies the predetermined criterion and shifts to the standby mode.

2-5. (Access to Crowd)

The mobile body control device, in the above embodiments, wherein in a case where the specific person approaches a crowd of a predetermined number or more of persons in such a way that a distance to the crowd is a predetermined distance, the control unit determines that the movement of the specific person satisfies the predetermined criterion and shifts to the standby mode.

2-6. (Decrease in Reliability of Predicted Trajectory of User)

The mobile body control device, in the above embodiments, wherein in a case where reliability of a predicted trajectory of the specific person is equal to or less than a threshold, the control unit determines that the movement of the specific person satisfies the predetermined criterion and shifts to the standby mode.

2-7. (Shifting to Standby Mode According to Standby Instruction)

The mobile body control device, in the above embodiments, further comprising a voice processing unit configured to receive utterance information from a person around the mobile body, wherein in a case where utterance information including an instruction to stand by is received from the specific person, the control unit determines that the movement of the mobile body satisfies the predetermined criterion, and shifts to the standby mode.

2-8. (Shifting to Standby Mode Upon Arrival at Destination)

The mobile body control device, in the above embodiments, wherein in a case where the traveling mode of traveling toward a destination is set and the mobile body arrives at the destination, the control unit determines that the movement of the mobile body satisfies the predetermined criterion and shifts to the standby mode.

2-9. (Returning to Station from Standby Mode)

The mobile body control device, in the above embodiments, wherein the control unit shifts from the standby mode to a wandering mode of moving to a station in which the mobile body is chargeable when a predetermined first time elapses from start of standby at the specific point.

2-10. (Returning from Destination to Station under Certain Condition)

The mobile body control device, in the above embodiments, wherein in a case where the traveling mode of traveling toward the destination is set, the mobile body arrives at the destination, and the destination is within a predetermined distance from a station in which the mobile body is chargeable, the control unit shifts to a wandering mode of moving to the station without shifting to the standby mode.

2-11. (Standby Mode without Moving to Station)

The mobile body control device, in the above embodiments, wherein in a case where a remaining amount of power for traveling of the mobile body is equal to or less than a threshold, the control unit shifts the control mode of the mobile body to an emergency mode of returning to a station in which the mobile body is chargeable, and in a case where the remaining amount of power of the mobile body is equal to or less than the threshold, and the station does not exist in a movable range based on the remaining amount of power, the control unit determines that the movement of the mobile body satisfies the predetermined criterion and shifts to the standby mode.

2-12. (Returning to Station when Time has Elapsed without Performing User Authentication)

The mobile body control device, in the above embodiments, further comprising an authentication unit configured to perform authentication of the specific person to start or resume use of the mobile body by the specific person, wherein when a predetermined second time elapses from the authentication of the specific person without performing authentication of the specific person, the control unit shifts to a wandering mode of moving to a station in which the mobile body is chargeable.

2-13. (Returning to Station when User does not Respond to Call for User)

The mobile body control device, in the above embodiments, further comprising a presentation unit configured to present predetermined information to a person around the mobile body, wherein in a case where the specific person is not detected from the sensor information for a predetermined third time during traveling of the mobile body, the control unit causes the presentation unit to output utterance information for calling for the specific person to return to a position of the mobile body, and when a predetermined fourth time elapses from the output of the utterance information in a state in which the specific person is not detected from the sensor information, the control unit shifts the control mode of the mobile body to a wandering mode of returning to a station in which the mobile body is chargeable.

2-14. (Shifting to Standby Mode in Case of Complete Loss)

The mobile body control device, in the above embodiments, wherein in a case where the specific person is not detected from the sensor information for a predetermined fifth time for shifting to the standby mode after last detection, the control unit shifts the control mode of the mobile body to the standby mode.

The invention is not limited to the foregoing embodiments, and various variations/changes are possible within the spirit of the invention.

What is claimed is:

1. A mobile body control device comprising:
one or more processors; and
a memory storing instructions which, when the instructions are executed by the one or more processors, cause the mobile body control device to function as:
an acquisition unit configured to acquire sensor information for recognizing an object around a mobile body, the sensor information including a captured image obtained by capturing a periphery of the mobile body;
a setting unit configured to set one of a plurality of control modes; and
a control unit configured to control traveling of the mobile body based on the set control mode and a result of detection of a specific person based on the sensor information,
wherein the plurality of control modes include a plurality of traveling modes of traveling together with the specific person when the person is walking, and a standby mode of standing by at a specific point until any one of the traveling modes is started or resumed,
the control unit controls the traveling of the mobile body in such a way that the mobile body travels together with the specific person when the person is walking in the plurality of traveling modes, and
in a case where it is determined that movement of the specific person or movement of the mobile body satisfies a predetermined criterion for the mobile body to wait while being away from the specific person, the control unit shifts from one of the traveling modes to the standby mode.

2. The mobile body control device according to claim 1, wherein in a case where the control mode of the mobile body shifts to the standby mode, the control unit moves from a first point where the shifting to the standby mode is made to the specific point and stands by.

3. The mobile body control device according to claim 2, wherein the control unit stands by in such a way that a front surface of the mobile body faces the first point when the mobile body arrives at the specific point.

4. The mobile body control device according to claim 1, wherein in a case where the specific person approaches a set of persons having a predetermined density or more in such a way that a distance to the set of persons is a predetermined distance, the control unit determines that the movement of the specific person satisfies the predetermined criterion and shifts to the standby mode.

5. The mobile body control device according to claim 1, wherein in a case where the specific person approaches a crowd of a predetermined number or more of persons in such a way that a distance to the crowd is a predetermined distance, the control unit determines that the movement of the specific person satisfies the predetermined criterion and shifts to the standby mode.

6. The mobile body control device according to claim 1, wherein in a case where reliability of a predicted trajectory of the specific person is equal to or less than a threshold, the control unit determines that the movement of the specific person satisfies the predetermined criterion and shifts to the standby mode.

7. The mobile body control device according to claim 1, further comprising a voice processing unit configured to receive utterance information from a person around the mobile body,
wherein in a case where utterance information including an instruction to stand by is received from the specific person, the control unit determines that the movement of the mobile body satisfies the predetermined criterion, and shifts to the standby mode.

8. The mobile body control device according to claim 1, wherein in a case where the traveling mode of traveling toward a destination is set and the mobile body arrives at the destination, the control unit determines that the movement of the mobile body satisfies the predetermined criterion and shifts to the standby mode.

9. The mobile body control device according to claim 1, wherein the control unit shifts from the standby mode to a wandering mode of moving to a station in which the mobile body is chargeable when a predetermined first time elapses from start of standby at the specific point.

10. The mobile body control device according to claim 8, wherein in a case where the traveling mode of traveling toward the destination is set, the mobile body arrives at the destination, and the destination is within a predetermined distance from a station in which the mobile body is chargeable, the control unit shifts to a wandering mode of moving to the station without shifting to the standby mode.

11. The mobile body control device according to claim 1, wherein in a case where a remaining amount of power for traveling of the mobile body is equal to or less than a threshold, the control unit shifts the control mode of the mobile body to an emergency mode of returning to a station in which the mobile body is chargeable, and
in a case where the remaining amount of power of the mobile body is equal to or less than the threshold, and the station does not exist in a movable range based on the remaining amount of power, the control unit determines that the movement of the mobile body satisfies the predetermined criterion and shifts to the standby mode.

12. The mobile body control device according to claim 1, further comprising an authentication unit configured to perform authentication of the specific person to start or resume use of the mobile body by the specific person,
wherein when a predetermined second time elapses from the authentication of the specific person without performing authentication of the specific person, the control unit shifts to a wandering mode of moving to a station in which the mobile body is chargeable.

13. The mobile body control device according to claim 1, further comprising a presentation unit configured to present predetermined information to a person around the mobile body,
wherein in a case where the specific person is not detected from the sensor information for a predetermined third time during traveling of the mobile body, the control unit causes the presentation unit to output utterance information for calling for the specific person to return to a position of the mobile body, and
when a predetermined fourth time elapses from the output of the utterance information in a state in which the specific person is not detected from the sensor information, the control unit shifts the control mode of the mobile body to a wandering mode of returning to a station in which the mobile body is chargeable.

14. The mobile body control device according to claim 1, wherein in a case where the specific person is not detected from the sensor information for a predetermined fifth time for shifting to the standby mode after last detection, the control unit shifts the control mode of the mobile body to the standby mode.

15. A mobile body control method comprising:
acquiring sensor information for recognizing an object around a mobile body, the sensor information including a captured image obtained by capturing a periphery of the mobile body;
setting one of a plurality of control modes; and
controlling traveling of the mobile body based on the set control mode and a result of detection of a specific person based on the sensor information,
wherein the plurality of control modes include a plurality of traveling modes of traveling together with the specific person when the person is walking, and a standby mode of standing by at a specific point until any one of the traveling modes is started or resumed,
in the controlling, the traveling of the mobile body is controlled in such a way that the mobile body travels together with the specific person when the person is walking in the plurality of traveling modes, and
in the controlling, in a case where it is determined that movement of the specific person or movement of the mobile body satisfies a predetermined criterion for the mobile body to wait while being away from the specific person, shifting from one of the traveling modes to the standby mode is made.

16. A non-transitory computer-readable storage medium storing a program for causing a computer to function as each unit of a mobile body control device, the mobile body control device including:
an acquisition unit that acquire sensor information for recognizing an object around a mobile body, the sensor information including a captured image obtained by capturing a periphery of the mobile body;
a setting unit that sets one of a plurality of control modes; and
a control unit that controls traveling of the mobile body based on the set control mode and a result of detection of a specific person based on the sensor information,
wherein the plurality of control modes include a plurality of traveling modes of traveling together with the specific person when the person is walking, and a standby mode of standing by at a specific point until any one of the traveling modes is started or resumed,
the control unit controls the traveling of the mobile body in such a way that the mobile body travels together with the specific person when the person is walking in the plurality of traveling modes, and
in a case where it is determined that movement of the specific person or movement of the mobile body satisfies a predetermined criterion for the mobile body to wait while being away from the specific person, the control unit shifts from one of the traveling modes to the standby mode.
